(19) United States
(12) Patent Application Publication
(10) Pub. No.: US 2015/0277617 A1
(43) Pub. Date: Oct. 1, 2015

(54) FLEXIBLE SENSOR

(71) Applicants: PAUL GWIN, Orangevale, CA (US); MARK E. SPRENGER, Folsom, CA (US)

(72) Inventors: PAUL GWIN, Orangevale, CA (US); MARK E. SPRENGER, Folsom, CA (US)

(21) Appl. No.: 14/228,838

(22) Filed: Mar. 28, 2014

(51) Int. Cl. G06F 3/044; G06F 3/041; G06F 3/0354; G01L 1/14

(52) U.S. Cl. CPC G06F 3/044; G01L 1/14; G06F 3/0412; G06F 3/0414; G06F 3/03547; G06F 2203/0338; G06F 2203/0339; G06F 2203/04101; G06F 2203/04112

(57) ABSTRACT

The present disclosure provides techniques for a flexible sensor. In particular, the present disclosure provides techniques for a flexible, capacitive flexible sensor. A computing device can include a flexible sensor to collect input. The computing device can also include a processor to process the input. A deformation of the flexible sensor changes a capacitance of the flexible sensor.

### TECHNICAL FIELD

The present techniques relate to a sensor. In particular, the present techniques relate to a flexible touch sensor.

### BACKGROUND

Modern computing devices incorporate a number of methods for interacting with the computing devices. These input methods can include keyboards, joysticks, and sensors, such as touch sensors. Examples of touch sensors can include resistive sensors and capacitive sensors, among others.

### BRIEF DESCRIPTION OF THE DRAWINGS

Certain exemplary embodiments are described in the following detailed description and in reference to the drawings, in which:

FIG. 1 is a block diagram of a computing device, in accordance with an embodiment;

FIG. 2 is an illustration of a touch sensor, in accordance with an embodiment;

FIGS. 3A-3D are illustrations deformation of the touch sensor, in accordance with an embodiment;

FIG. 4 is an illustration of another touch sensor, in accordance with an embodiment;

FIG. 5A is a front view illustration of a computing device, in accordance with an embodiment;

FIG. 5B is a back view illustration of the computing device, in accordance with an embodiment;

FIG. 5C is a side view illustration of the computing device, in accordance with an embodiment;

FIG. 6 is a process flow diagram of a method of manufacturing the touch sensor, in accordance with an embodiment; and

FIG. 7 is a process flow diagram of an example of a method of using the touch sensor, in accordance with an embodiment.

### DETAILED DESCRIPTION OF SPECIFIC EMBODIMENTS

Current methods of interacting with a computing device include touchpads. Touchpads are typically made of rigid materials, resulting in a rigid touchpad. Due to this rigidity, touchpads can usually only be placed on a flat surface, limiting incorporation of touchpads into computing devices. In addition, this rigidity results in an increased risk of damage to the touchpad.

Embodiments disclosed herein provide techniques for a touch sensor. In particular, embodiments disclosed herein provide techniques for a flexible touch sensor. By forming the touchpad from a flexible polymer, the touchpad can be flexible. These flexible touchpads can be located on a variety of surfaces, including flat surfaces and curved surfaces. Further, because these touchpads are flexible, the touchpads are less susceptible to damage than traditional rigid touchpads. Moreover, by manufacturing the touchpads from inexpensive materials using a simple manufacturing method, the ease of manufacturing can increase, while the cost of manufacturing can decrease.

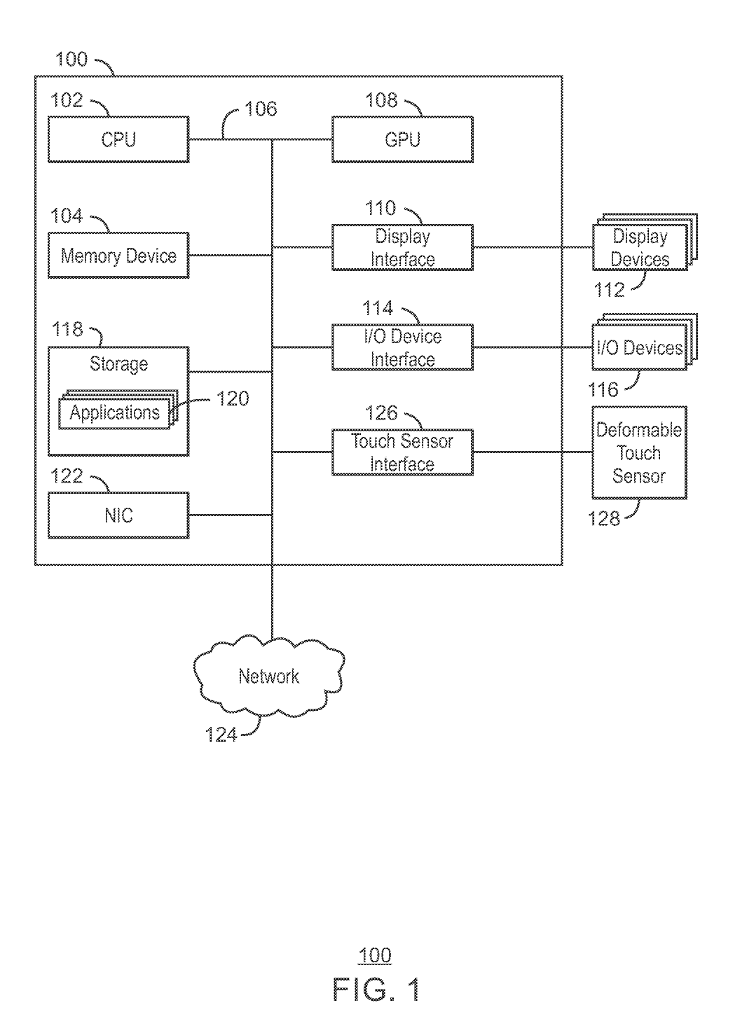

FIG. 1 is a block diagram of a computing device 100 that can be used in accordance with embodiments. The computing device 100 can be, for example, a laptop computer, desktop computer, tablet computer, mobile device, or server, among others. In particular, the computing device 100 can be a mobile device such as a cellular phone, a smartphone, a personal digital assistant (PDA), or a tablet. The computing device 100 can include a central processing unit (CPU) 102 that is configured to execute stored instructions, as well as a memory device 104 that stores instructions that are executable by the CPU 102. The CPU can be coupled to the memory device 104 by a bus 106. Additionally, the CPU 102 can be a single core processor, a multi-core processor, a computing cluster, or any number of other configurations. Furthermore, the computing device 100 can include more than one CPU 102. The memory device 104 can include random access memory (RAM), read only memory (ROM), flash memory, or any other suitable memory systems. For example, the memory device 104 can include dynamic random access memory (DRAM).

The computing device 100 can also include a graphics processing unit (GPU) 108. As shown, the CPU 102 can be coupled through the bus 106 to the GPU 108. The GPU 108 can be configured to perform any number of graphics operations within the computing device 100. For example, the GPU 108 can be configured to render or manipulate graphics images, graphics frames, videos, or the like, to be displayed to a user of the computing device 100. In some embodiments, the GPU 108 includes a number of graphics engines, wherein each graphics engine is configured to perform specific graphics tasks, or to execute specific types of workloads.

The CPU 102 can be linked through the bus 106 to a display interface 110 configured to connect the computing device 100 to a display device 112. The display device 112 can include a display screen that is a built-in component of the computing device 100. The display device 112 can also include a computer monitor, television, or projector, among others, that is externally connected to the computing device 100.

The CPU 102 can also be connected through the bus 106 to an input/output (I/O) device interface 114 configured to connect the computing device 100 to one or more I/O devices 116. The I/O devices 116 can include, for example, a keyboard and a pointing device, wherein the pointing device can include a touchpad or a touchscreen, among others. The I/O devices 116 can be built-in components of the computing device 100, or can be devices that are externally connected to the computing device 100.

The computing device also includes a storage device 118. The storage device 118 is a physical memory such as a hard drive, a solid state drive, an optical drive, a thumbdrive, an array of drives, or any combinations thereof. The storage device 118 can also include remote storage drives. The storage device 118 includes any number of applications 120 that are configured to run on the computing device 100.

The computing device 100 can also include a network interface controller (NIC) 122. The NIC 122 can be configured to connect the computing device 100 through the bus 106 to a network 124. The network 124 can be a wide area network (WAN), local area network (LAN), or the Internet, among others.

The computing device 100 also includes a touch sensor interface 126 to connect the computing device 100 through the bus 106 to a deformable touch sensor 128. The deformable touch sensor 128 is a flexible, capacitive touch sensor. The capacitance of the touch sensor 128 is changed by deforming the touch sensor 128. In some cases, the deformable touch sensor 128 includes electrodes layered with insulators. For example, the insulator can be a silicone material, such as polydimethylsiloxane (PDMS).

The block diagram of FIG. 1 is not intended to indicate that the computing device 100 is to include all of the components shown in FIG. 1. Further, the computing device 100 can include any number of additional components not shown in FIG. 1, depending on the details of the specific implementation.

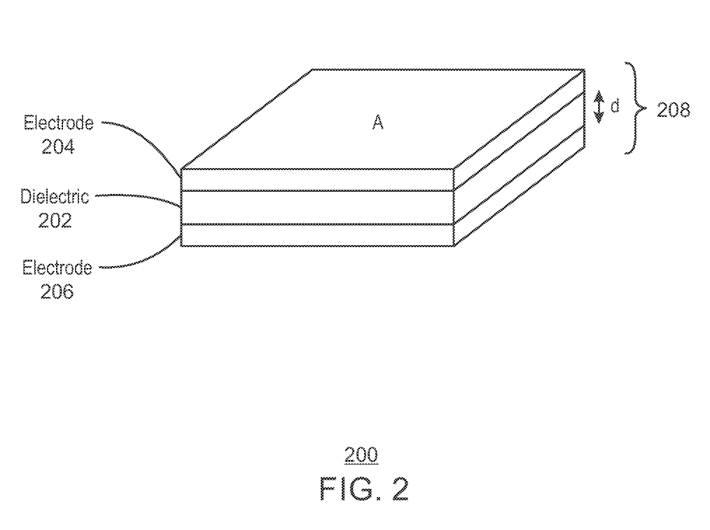

FIG. 2 is an illustration of a touch sensor 200. The touch sensor 200 includes a dielectric material 202 layered between electrodes 204, 206. While the touch sensor 200 is illustrated as a single dielectric 202 layered between two electrodes 204, 206, it is to be understood that the touch sensor 200 can include additional dielectric and electrode layers, depending on the design of the touch sensor 200. In an example, electrode 204 can be the same material as electrode 206. In another example, electrode 204 can be a different material from electrode 206. The dielectric 202 and the electrodes 204, 206 can be formed of a polymer, such as a flexible polymer. The polymer may also be an amorphous polymer. In examples, the polymer can be a silicone, such as polydimethylsiloxane (PDMS). Furthermore, the electrodes 206, 206 can be a silicone and a conducting medium, such as carbon, or any other suitable conducting material, compounded into the silicone.

The high flexibility of the touch sensor 200 enables the touch sensor 200 to be highly conformable compared to typical touchpads. Accordingly, the touch sensor 200 can be applied to a surface with a variety of shapes, including flat surfaces and curved surfaces. In the process of forming the touch sensor 200 to a curved surface, regions of the touch sensor 200 may deform more than other regions of the touch sensor 200, changing the capacitance of these deformed regions as compared to the less deformed regions of the touch sensor 200. By calibrating the touch sensor 200 after forming the touch sensor 200 to the curved surface, this change in capacitance can be negated. The touch sensor 200 additionally supports a strain up to 400%, such as up to 350%. This high supported strain enables the force/deflection curve of the touch sensor 200 to be made less sensitive when compared to a more rigid touchpad. In this sense, sensitivity relates to the force versus the deflection of the touch sensor 200. When a sensor 200 is very stiff, a large force causes a small deflection in the sensor 200, making the sensor 200 very responsive to small deflections. This responsiveness to small deflection makes the input hard to control for the user. However, when the force is low and a large strain results due to the low modulus sensor material, the change of capacitance is large, resulting in a large signal input, so the user has greater control of the input signal by applying a force to the touch sensor 200 (i.e., the sensor 200 is less sensitive) and the touch sensor 200 is less prone to errors.

The capacitance of the touch sensor 200 is changed by deforming the touch sensor 200. In some cases, deforming the touch sensor means applying pressure to the touch sensor such that the shape of the touch sensor is altered. Capacitance is a function of the electrode area A, the electrode charge, the distance d between electrodes, and the permittivity of the volume between charge plates. When a force is exerted on the touch sensor 200, the electrode area A deforms and the distance d changes, which in turn changes the capacitance of the touch sensor 200. The capacitance is sensed by a circuit (not illustrated) and correlated to a force applied to the touch sensor 200.

The force applied to the touch sensor 200 and the resulting shape change of the touch sensor 200 as a function of how the force is applied will the resultant capacitance of the touch sensor 200. Force of the same magnitude can be applied in different directions and the magnitude of change in the capacitance of the touch sensor 200 will vary based on the type of loading. A control algorithm can detect a variation in capacitance of neighboring regions and determine the direction of the force. Alternatively, an outer insulator (the insulator contacted by a user) can be a more rigid structure that moderates the shape factor imparting a load on the touch sensor. Further, the type of loading (direction and shape deformation characteristics) can be calibrated, patterned, and sensed for intelligent interpretation of the force signature.

The change in capacitance of the touch sensor 200 initiates a response in a computing device including the touch sensor 200. This change in capacitance can be an input method. The touch sensor 200 can include a variety of input methods, such as stretching the touch sensor 200, squeezing the touch sensor 200, and a fringe field effect, among others. The fringe field effect is when a electric field surrounding an electrode is changed due to introducing an external material with dielectric properties into the fringe field. This intrusion of external material changes the capacitance of the electrode and is therefore interpreted as an input. For example, when a user places a finger close to the touch sensor 200 without touching the touch sensor 200, the response of the touch sensor 200 will change. The response can be correlated to a force applied to deform the touch sensor 200 and a shape factor of an object imparting the force. The response can be calibrated based on the amount of force applied to deform the touch sensor 200, the type of deformation of the touch sensor 200, and an amount of deformation of the touch sensor 200, among other things. Responses to input can be configurable by a user.

Because force is an analog input, as the amount of force changes, the response of the computing device can also change. In an example, the computing device can be calibrated to initiate different responses depending on the amount of force. These responses can be calibrated to respond linearly or nonlinearly to the force. For example, when a small force is applied to the touch sensor 200, a first response can be initiated. When a large force is applied to the touch sensor 200, a second response can be initiated. In another example, the touch sensor 200 can be calibrated to a particular user. For example, a first user can calibrate a first range of force to apply to the touch sensor 200 and a second user can calibrate a second range of force to apply to the touch sensor 200. When a force within the first range of force is applied to the touch sensor 200, the computing device can initiate the first user's profile. When a force within the second range of force is applied to the touch sensor 200, the computing device can initiate the second user's profile.

The touch sensor 200 can include precision force capability. Precision force capability refers to an ability to respond accurately such that a force magnitude is useful as an input because of reasonable deformations in the touch sensor 200 combined with a modulus of elasticity of the sensing material elements that are compatible with an expected load. In an example, a user may calibrate the touch sensor 200 by applying a force to the touch sensor 200 that is compatible with the highest force the user is comfortable imparting on the touch sensor 200. The user can set the maximum response of the touch sensor 200 at that force, thereby setting the user preferences of the touch sensor 200.

The touch sensor 200 can include a plurality of electrodes coupled together in a grid pattern. By determining which electrode in the grid pattern is contacted by a user, the touch sensor 200 also includes position sensing. The electrodes can be stratified such that as a user's finger or hand approaches the grid, the capacitance of an electrode is changed. In this way, the touch sensor can include any suitable range. For example, the sensing range of the touch sensor can extend from 1 g to 10 kg, such as 2 g to 8 kg, 3 g to 7 kg, 4 g to 6 kg, 5 g to 5 kg, or 6 g to 4 kg. Additionally, the touch sensor 200 can be less than 500 μm thick, such as less than 200 μm thick, such as less than 150 μm thick. For example, each layer 202, 204, 206 of the touch sensor can be 30 μm thick, resulting in a touch sensor 90 μm thick.

The touch sensor 200 can support peripheral device applications. For example, the touch sensor 200 can be a device that is removable coupled to a computing device. Moreover, in examples, the touch sensor 200 can be shaped as a large rubber band that extends around the housing of the computing device, or other geometries. The touch sensor 200 can communicate wirelessly with the computing device as the touch sensor 200 is manipulated to initiate a response from the computing device. For example, the touch sensor 200 can act as a remote control for the computing device. The touch sensor 200 can be included in the computing device. In another example, the touch sensor 200 can be an external device, such as an accessory purchased separately from the computing device.

The illustration of FIG. 2 is not intended to indicate that the touch sensor 200 is to include all of the components shown in FIG. 2. Further, the touch sensor 200 can include any number of additional components not shown in FIG. 2, depending on the details of the specific implementation.

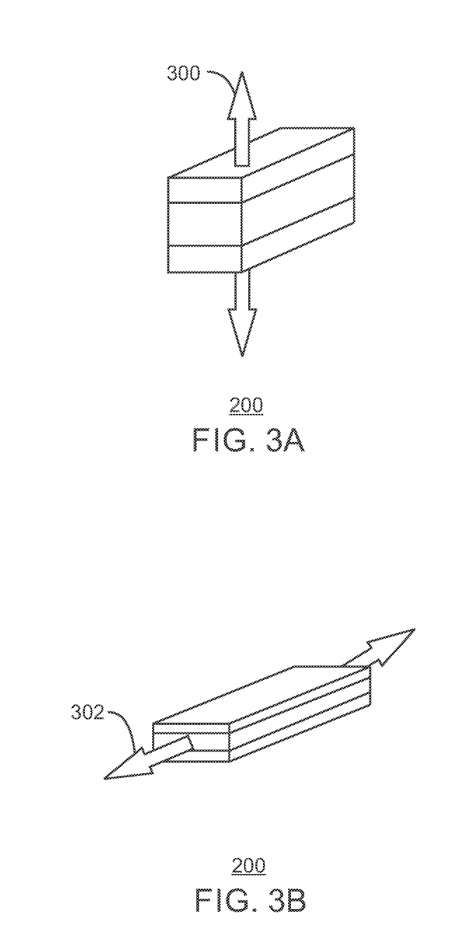

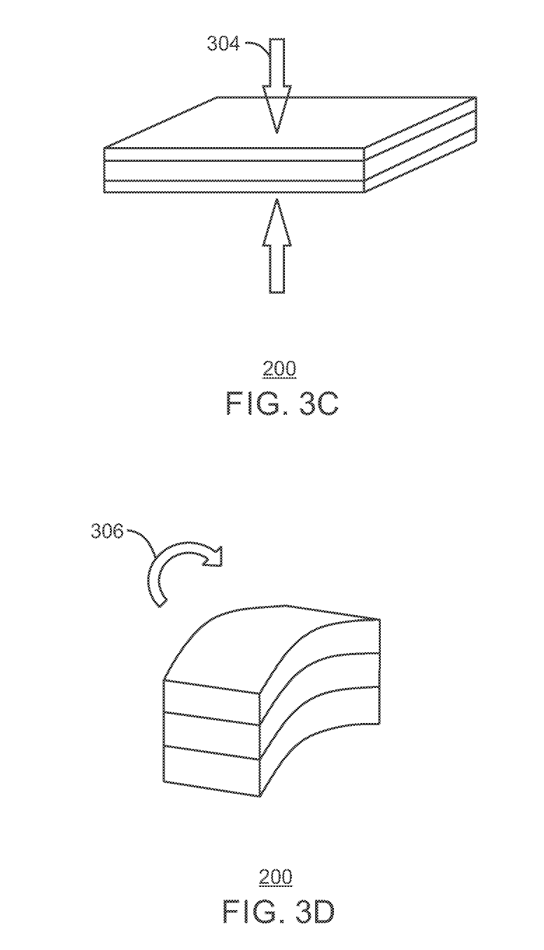

FIGS. 3A-3D are illustrations of deformation of the touch sensor 200. The capacitance of the touch sensor 200 can be changed by deforming the touch sensor 200. The touch sensor 200 can be deformed in any number of ways. For example, as illustrated by FIG. 3A, the touch sensor 200 can be deformed by stretching the sensor vertically 300. The touch sensor 200 can be deformed by deflecting a chassis panel on which the touch sensor 200 is mounted. In another example, illustrated by FIG. 3B, the touch sensor 200 can be deformed by stretching the sensor horizontally 302. In a further example, illustrated by FIG. 3C, the touch sensor 200 can be deformed by compressing the touch sensor 200 vertically 304. In other examples, illustrated by FIG. 3D, the touch sensor 200 can be bent 306, inducing strain in the touch sensor 200, or twisted. In addition, the touch sensor 200 can be deformed in any other way not illustrated here.

The touch sensor 200 can be designed to react to any deformation. For example, the touch sensor 200 can be designed to react to a light touch on the touch sensor 200 resulting in a small deformation. In another example, the touch sensor 200 can be designed to react to a heavy touch on the touch sensor 200 resulting in a large deformation or a small deformation. In another example, the touch sensor 200 can measure the degree of deformation of the touch sensor 200 and can initiate a response based on the degree of deformation.

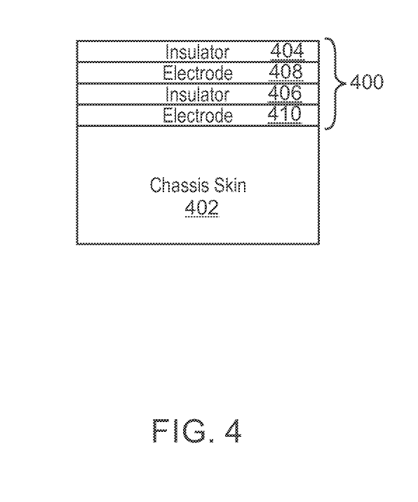

FIG. 4 is an illustration of another touch sensor 400. The touch sensor 400 may be similar to a touch sensor 200 as described with respect to FIGS. 2 and 3. The touch sensor 400 can be placed on a chassis skin 402. For example, the chassis skin 402 can be a housing of a computing device. The touch sensor 400 includes insulators 404, 406 layered with electrodes 408, 410. The touch sensor 400 can include any suitable number of layers 404, 406, 408, 410, depending on the design of the touch sensor 400. In another example, the touch sensor 400 can be placed directly on the chassis skin 402 such that the chassis skin 402 replaces the electrode 410. The touch sensor can be less than 500 μm thick.

The touch sensor 400 is a flexible touch sensor, allowing the touch sensor to be placed over a variety of surfaces having a variety of shapes, including flat and curved surfaces. By contrast, a typical touch sensor is relatively rigid. Furthermore, a typical touch sensor employs a variety of different materials, increasing the cost and complexity of manufacturing the typical touch sensor. For example, some typical touch sensors can include indium tin oxide (ITO), which is a costly material in limited supply. These materials are typically rigid, low strain, planar materials. Moreover, these sensors are typically manufactured using a high cost deposition process. Additionally, many existing touch sensors include multiple piezo elements in order to obtain a force measurement from the rigid panel touch pad. By contrast, as described above, the touch sensor 400 employs less costly materials and a straightforward design, thereby making the touch sensor 400 less expensive and less complex to manufacture compared to typical touch sensors.

Additionally, the simplicity of manufacturing allows the touch sensors 400 to be created at low cost. The touch sensor 400 can be less than 500 μm thick, such as less than 200 μm thick, whereas typical touch sensors are not less than 2.8 mm thick. For example, each layer 404, 406, 408, 410 can be 30 μm thick, resulting in a touch sensor 120 μm thick. Further, the touch sensor 400 can have a supportable stain limited only by the materials of the touch sensor 400. For example, the touch sensor 400 can have a strain capability up to 800% or more, such as up to 700%, up to 600%, up to 500%, up to 400, or up to 300%. For example, the touch sensor 400 can have a strain capability of 350%. By contrast, the typical touch sensor can only support a strain up to 2%. This limited supportable strain of the typical touch sensor limits potential applications of the typical touch sensor. The high supportable strain of the touch sensor 400 allows the force/deflection curve of the touch sensor 400 to be made less sensitive than the typical touch sensor, resulting in greater potential control than the typical touch sensor.

The touch sensor 400 can be applied to the chassis skin 402 in a variety of ways. For example, an adhesive can couple the touch sensor 400 to the chassis skin 402. In another example, the touch sensor 400 can be applied as a sleeve over the chassis skin 402. In a further example, the touch sensor 400 can be manufactured directly onto the chassis skin 402. By contrast, the typical touch sensor employs a sub frame and is integrated into a chassis in a window frame concept, thereby limiting feasible integration options.

Examples of the typical touch sensor include Projected Capacitance type touch sensors, such as a force sensor with touch placement and a 4 post piezo sensor, among others. In addition to the advantages, listed above, of the touch sensor 400 to the typical touch sensor, the touch sensor 400 can be a multi-touch sensor, which detects multiple points of contact. In addition, neither the Projected Capacitance type touch sensor, nor the 4 Post Piezo sensors include the haptic capabilities (how the sensor feels to a user's touch), peripheral support, 3D geometry, thickness, and low costs of the touch sensor 400.

The illustration of FIG. 4 is not intended to indicate that the touch sensor 400 is to include all of the components shown in FIG. 4. Further, the touch sensor 400 can include any number of additional components not shown in FIG. 4, depending on the details of the specific implementation.

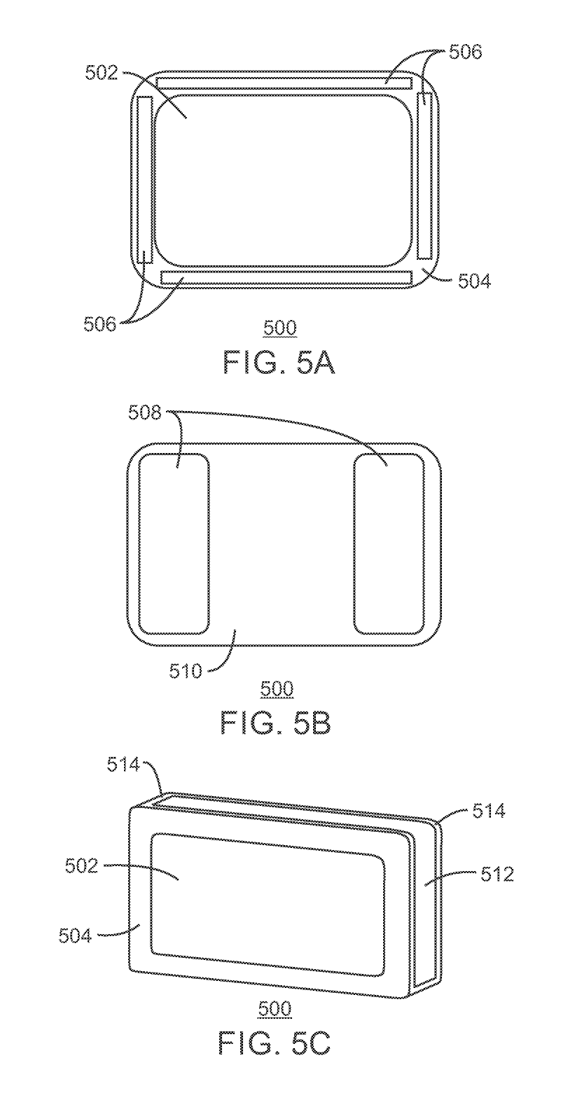

FIGS. 5A-5C are illustrations of a computing device including the touch sensor. As illustrated by FIG. 5A, the computing device 500 can include a display device 502 and a front surface 504 of a housing bordering the display device 502. A touch sensor 506 or a plurality of touch sensors 506 can be included on the front surface 504 or the housing. In another example, illustrated by FIG. 5B, the computing device 500 can include a touch sensor(s) 508 on the back surface 510 of the computing device 500. As illustrated by FIG. 5C, the computing device 500 can further include a touch sensor 512 on at least one side 514 of the computing device 500. The computing device 500 can include a touch sensor 506, 508, 512 on a front surface 504, back surface 510, or side surface 514, or any combination thereof. The touch sensor 506, 508, 512 can extend over a portion of the surface or the entirety of the surface on which the touch sensor 506, 508, 512 is positioned. In another example, one or more of the touch sensors 506, 508, 512 can be integrated with the housing.

The touch sensors 506, 508, 512, can extend over a flat surface or a non-flat surface, such as a curved surface. For example, as illustrated in FIG. 5C, the touch sensor 512 can extend around a curved corner between side surfaces 514. The touch sensors can be placed on the computing device 500 to allow the user to interact with the computing device 500 without interacting with the display device 502 of the computing device 500. The touch sensors 506, 508, 512 can be capacitive touch sensors, the capacitance of which is changed by changing the deformation of the touch sensor 206, such as touch sensor 200. The touch sensors 506, 508, 512 can receive input from a user. For example, the touch sensors 506, 508, 512 can detect a sliding finger, pressure from a user's finger or hand, tapping from a user's finger or hand, or any other type of interacting with the touch sensor.

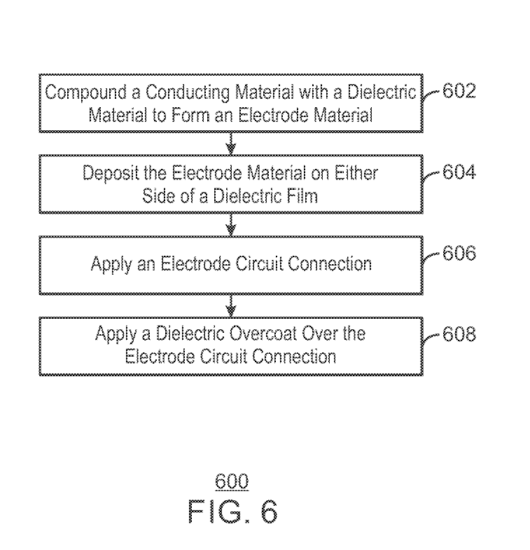

FIG. 6 is a process flow diagram of an example of a method of manufacturing a deformable touch sensor. At block 602, a conducting material can be compounded with a dielectric material to form an electrode material. The conducting material can be any suitable type of conducting material, such as carbon. The dielectric material can be any suitable type of polymer, such as a flexible polymer. For example, the dielectric material can be a silicone material, such as polydimethylsiloxane. The material can be chosen based on the insulation properties of the material and the tactile feel of the material, as well as the elastic modulus of the material, and the ability to compound the dielectric material with a conducting medium.

At block 604, the electrode material can be deposited on either side of a dielectric film. The dielectric film can be any suitable type of polymer. For example, the dielectric film can be a silicone material, such as polydimethylsiloxane. In another example, the dielectric film can be a polyester film, such as a polyethylene terephthalate (PET) film or a biaxially-oriented polyethylene terephthalate (BoPET) film. The electrode material can be deposited on the dielectric film using any suitable deposition method. At block 606, an electrode circuit connection can be applied.

For example, the electrode can be a silicone compounded with a conducting particle. To make the circuit connection, the silicone compounded with the conducting particle can be printed onto the connecting electrode, clamped to the electrode, or coupled to the connecting electrode with any other suitable method.

At block 608, a dielectric overcoat can be applied over the electrode circuit connection. The dielectric overcoat can be any suitable type of insulating material, such as silicone. The dielectric overcoat can be applied by any suitable method, such as printing.

In an example, the touch sensor can be manufactured and then applied to a chassis. The chassis can be a housing of a computing device. For example, the touch sensor can be coupled to the chassis using an adhesive. In another example, the touch sensor can be formed as a sleeve and the sleeve can be applied such that the touch sensor overlays the chassis. In another example, the touch sensor can be manufactured directly on the chassis. For example, the touch sensor can be screen-printed or ink jet printed on the chassis. The touch sensor can be formed on an internal or an external surface of the chassis. In an example, the touch sensor can be formed such that the touch sensor is sandwiched between parts of the chassis. By forming the touch sensor directly on the chassis, either inside or external, a 3D geometry can be formed in a non-pre-stretched form. In an example, the chassis can replace an insulator layer of the touch sensor.

The process flow diagram of FIG. 6 is not intended to indicate that the method 600 is to include all of the blocks shown in FIG. 6. Further, the method 600 can include any number of additional blocks not shown in FIG. 6, depending on the details of the specific implementation.

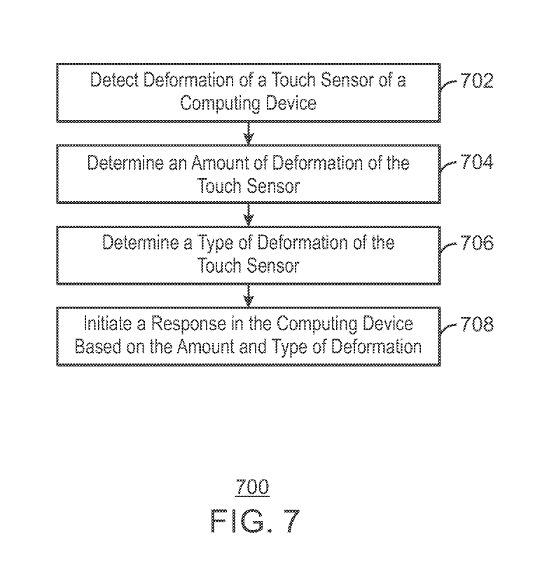

FIG. 7 is a process flow diagram of an example of a method of using a touch sensor. At block 702, a touch sensor of a computing device can detect deformation of the touch sensor. The touch sensor can be a flexible, deformable touch sensor. Deformation of the touch sensor can cause a change in capacitance of the touch sensor. The touch sensor can be deformed in a variety of ways, including stretching the touch sensor vertically, stretching the touch sensor horizontally, compressing the touch sensor, bending the touch sensor, twisting the touch sensor, or otherwise deforming the touch sensor. The touch sensor can be deformed by a user's finger or hand. Additionally, the touch sensor can be deformed by manipulating a chassis on which the touch sensor is mounted.

At block 704, the touch sensor can determine an amount of deformation of the touch sensor. At block 706, the type of deformation of the touch sensor can be determined. At block 708, a response in the computing device can be initiated based on the amount and type of deformation. For example, when a small force is applied, a first response can be initiated and when a large force is applied, a second response can be initiated. The response can be programmed by a user. In an example, the response can be determined based on the application in which the response is to be initiated.

The process flow diagram of FIG. 7 is not intended to indicate that the method 700 is to include all of the blocks shown in FIG. 7. Further, the method 700 can include any number of additional blocks not shown in FIG. 7, depending on the details of the specific implementation.

### Example 1

A computing device is described herein. The computing device includes a flexible sensor to collect input. The computing device also includes a processor to process the input. A deformation of the flexible sensor is to change a capacitance of the flexible sensor.

The flexible sensor can be coupled to a housing of the computing device. The flexible sensor and the housing are joined by the flexible sensor coupled to the housing with an adhesive, the flexible sensor a sleeve overlying the housing, the flexible sensor integrated with the housing, the flexible sensor sandwiched between parts of a computer chassis, or any combination thereof. The change of the capacitance is to initiate a response from the computing device. The response is correlated to a force applied to deform the flexible sensor and a shape factor of an object imparting the force. The flexible sensor includes at least two electrodes and a dielectric between the electrodes. The flexible sensor includes a flexible polymer. The flexible sensor includes at least two electrodes and a dielectric between the electrodes, and wherein the electrodes include a silicone compounded with a conducting medium. The flexible sensor can be deformed by compressing the touch sensor, stretching the flexible sensor vertically, stretching the flexible sensor horizontally, bending the touch sensor, twisting the touch sensor, or any combination thereof. A thickness of the flexible sensor is less than 500 μm. The flexible sensor can include a sensing range of 5 grams to 5 kg. The flexible sensor can include a supportable strain of at least 350%.

### Example 2

A flexible sensor is described herein. The flexible sensor includes at least two electrodes and a dielectric between the electrodes. A deformation of the flexible sensor is to change a capacitance of the touch sensor.

The flexible sensor includes a flexible polymer. The electrodes can include a silicone compounded with a conducting medium. A first electrode can include a first material and the second electrode can include a second material. The flexible sensor can be deformed by compressing the touch sensor, stretching the flexible sensor vertically, stretching the flexible sensor horizontally, bending the touch sensor, twisting the touch sensor, or a combination thereof. The flexible sensor can be mounted on a chassis and the flexible sensor can be deformed by manipulating the chassis. The chassis can be a housing of a computing device. The flexible sensor can determine an amount of force applied to deform the touch sensor. A thickness of the flexible sensor can be less than 500 μm. The flexible sensor can include a sensing range of 5 grams to 5 kg. The flexible sensor can include a supportable strain of 350%. The change in capacitance can be to initiate a response from a computing device. The flexible sensor can include a plurality of electrodes coupled together in a grid pattern. A location of a user touch can be determined via the grid pattern.

### Example 3

A method is described herein. The method includes detecting a deformation of a flexible sensor of a computing device. The method also includes determining a force applied in deforming the touch sensor. The method further includes initiating a reaction in the computing device based on the force.

The method can further include determining a shape factor of an object applying the force. The method can further include determining a type of deformation of the touch sensor. The method can further include determining an amount of deformation of the touch sensor. Deforming the flexible sensor can include compressing the touch sensor, stretching the flexible sensor vertically, stretching the flexible sensor horizontally, bending the touch sensor, twisting the touch sensor, or a combination thereof. The flexible sensor can include a flexible polymer. Deforming the flexible sensor is to change a capacitance of the touch sensor. The reaction in the computing device can be initiated based on the change in the capacitance. The flexible sensor can be coupled to a housing of the computing device. The flexible sensor and the housing can be joined by the flexible sensor coupled to the housing with an adhesive, the flexible sensor including a sleeve overlying the housing, the flexible sensor integrated with the housing, the flexible sensor sandwiched between parts of a computer chassis, or any combination thereof.

### Example 4

A method is described herein. The method includes means for detecting a deformation of a flexible sensor of a computing device. The method also includes means for determining a force applied in deforming the touch sensor. The method further includes means for initiating a reaction in the computing device based on the force.

The method can further include means for determining a shape factor of an object applying the force. The method can further include means for determining a type of deformation of the touch sensor. The method can further include means for determining an amount of deformation of the touch sensor. Deforming the flexible sensor can include compressing the touch sensor, stretching the flexible sensor vertically, stretching the flexible sensor horizontally, bending the touch sensor, twisting the touch sensor, or a combination thereof. The flexible sensor can include a flexible polymer. Deforming the flexible sensor is to change a capacitance of the touch sensor. The reaction in the computing device can be initiated based on the change in the capacitance. The flexible sensor can be coupled to a housing of the computing device. The flexible sensor and the housing can be joined by the flexible sensor coupled to the housing with an adhesive, the flexible sensor including a sleeve overlying the housing, the flexible sensor integrated with the housing, the flexible sensor sandwiched between parts of a computer chassis, or any combination thereof.

### Example 5

A tangible, non-transitory, computer-readable storage medium is described herein. The tangible, non-transitory, computer-readable storage medium includes code to direct the processor to detect a deformation of a flexible sensor of a computing device. The code also directs the processor to determine a force applied in deforming the touch sensor. The code further directs the processor to initiate a reaction in the computing device based on the force.

The code can further direct the processor to determine a shape factor of an object applying the force. The code can further direct the processor to determine a type of deformation of the touch sensor. The code can further direct the processor to determine an amount of deformation of the touch sensor. Deforming the flexible sensor can include compressing the touch sensor, stretching the flexible sensor vertically, stretching the flexible sensor horizontally, bending the touch sensor, twisting the touch sensor, or a combination thereof. The flexible sensor can include a flexible polymer. Deforming the flexible sensor is to change a capacitance of the touch sensor. The reaction in the computing device can be initiated based on the change in the capacitance. The flexible sensor can be coupled to a housing of the computing device. The flexible sensor and the housing can be joined by the flexible sensor coupled to the housing with an adhesive, the flexible sensor including a sleeve overlying the housing, the flexible sensor integrated with the housing, the flexible sensor sandwiched between parts of a computer chassis, or any combination thereof.

### Example 6

A computing device is described herein. The computing device includes logic to detect a deformation of a flexible sensor of a computing device. The computing device also includes logic to determine a force applied in deforming the touch sensor. The computing device further includes logic to initiate a reaction in the computing device based on the force.

The computing device can further include logic to determine a shape factor of an object applying the force. The computing device can further include logic to determine a type of deformation of the touch sensor. The computing device can further include logic to determine an amount of deformation of the touch sensor. Deforming the flexible sensor can include compressing the touch sensor, stretching the flexible sensor vertically, stretching the flexible sensor horizontally, bending the touch sensor, twisting the touch sensor, or a combination thereof. The flexible sensor can include a flexible polymer. Deforming the flexible sensor is to change a capacitance of the touch sensor. The reaction in the computing device can be initiated based on the change in the capacitance. The flexible sensor can be coupled to a housing of the computing device. The flexible sensor and the housing can be joined by the flexible sensor coupled to the housing with an adhesive, the flexible sensor including a sleeve overlying the housing, the flexible sensor integrated with the housing, the flexible sensor sandwiched between parts of a computer chassis, or any combination thereof.

In the foregoing description and claims, the terms “coupled” and “connected,” along with their derivatives, can be used. It should be understood that these terms are not intended as synonyms for each other. Rather, in particular embodiments, “connected” can be used to indicate that two or more elements are in direct physical or electrical contact with each other. “Coupled” can mean that two or more elements are in direct physical or electrical contact. However, “coupled” can also mean that two or more elements are not in direct contact with each other, but yet still co-operate or interact with each other.

Some embodiments can be implemented in one or a combination of hardware, firmware, and software. Some embodiments can also be implemented as instructions stored on a machine-readable medium, which can be read and executed by a computing platform to perform the operations described herein. A machine-readable medium can include any mechanism for storing or transmitting information in a form readable by a machine, e.g., a computer. For example, a machine-readable medium can include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “can”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases can each have a same reference number or a different reference number to suggest that the elements represented could be different and/or similar. However, an element can be flexible enough to have different implementations and work with some or all of the systems shown or described herein. The various elements shown in the figures can be the same or different. Which one is referred to as a first element and which is called a second element is arbitrary.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter can be practiced without the specific details. In other instances, well-known features, components, or modules were omitted, simplified, combined, or split in order not to obscure the disclosed subject matter.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

While the present techniques can be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A computing device, comprising:
a flexible sensor to collect input; and
a processor to process the input,
wherein a deformation of the flexible sensor is to change a capacitance of the flexible sensor.

2. The computing device of claim 1, wherein the flexible sensor is coupled to a housing of the computing device.

3. The computing device of claim 2, wherein the flexible sensor and the housing are joined by the flexible sensor coupled to the housing with an adhesive, the flexible sensor comprising a sleeve overlying the housing, the flexible sensor integrated with the housing, the flexible sensor sandwiched between parts of a computer chassis, or any combination thereof.

4. The computing device of claim 1, wherein the change of the capacitance is to initiate a response from the computing device.

5. The computing device of claim 4, wherein the response is correlated to a force applied to deform the flexible sensor and a shape factor of an object imparting the force.

6. The computing device of claim 1, wherein the flexible sensor comprises at least two electrodes and a dielectric between the electrodes.

7. The computing device of claim 1, wherein the flexible sensor comprises a flexible polymer.

8. The computing device of claim 7, wherein the flexible sensor comprises at least two electrodes and a dielectric between the electrodes, and wherein the electrodes comprise a silicone compounded with a conducting medium.

9. The computing device of claim 1, wherein the flexible sensor is deformed by compressing the flexible sensor, stretching the flexible sensor vertically, stretching the flexible sensor horizontally, bending the flexible sensor, twisting the flexible sensor, or any combination thereof.

10. The computing device of claim 1, wherein a thickness of the flexible sensor is less than 500 μm.

11. The computing device of claim 1, wherein the flexible sensor comprises a sensing range of 5 grams to 5 kg.

12. The computing device of claim 1, wherein the flexible sensor comprises a supportable strain of at least 350%.

13. A flexible sensor, comprising:
at least two electrodes; and
a dielectric between the electrodes,
wherein a deformation of the flexible sensor is to change a capacitance of the flexible sensor.

14. The flexible sensor of claim 13, wherein the flexible sensor comprises a flexible polymer.

15. The flexible sensor of claim 13, wherein the electrodes comprise a silicone compounded with a conducting medium.

16. The flexible sensor of claim 13, wherein a first electrode comprises a first material and wherein the second electrode comprises a second material.

17. The flexible sensor of claim 13, wherein the flexible sensor is deformed by compressing the flexible sensor, stretching the flexible sensor vertically, stretching the flexible sensor horizontally, bending the flexible sensor, twisting the flexible sensor, or a combination thereof.

18. The flexible sensor of claim 13, wherein the flexible sensor is mounted on a chassis and wherein the flexible sensor is deformed by manipulating the chassis.

19. The flexible sensor of claim 18, wherein the chassis comprises a housing of a computing device.

20. The flexible sensor of claim 13, wherein the flexible sensor is to determine an amount of force applied to deform the flexible sensor.

21. The flexible sensor of claim 13, wherein a thickness of the flexible sensor is less than 500 μm.

22. The flexible sensor of claim 13, wherein the flexible sensor comprises a sensing range of 5 grams to 5 kg.

23. The flexible sensor of claim 13, wherein the flexible sensor comprises a supportable strain of at least 350%.

24. The flexible sensor of claim 13, wherein the change in capacitance is to initiate a response from a computing device.

25. The flexible sensor of claim 13, wherein the flexible sensor comprises a plurality of electrodes coupled together in a grid pattern.

26. The flexible sensor of claim 25, wherein a location of a user flexible is to be determined via the grid pattern.

27. A computing device, comprising:
logic to detect a deformation of a flexible sensor of a computing device;
logic to determine a force applied in deforming the flexible sensor; and
logic to initiate a reaction in the computing device based on the force.

28. The computing device of claim 27, further comprising logic to determine a shape factor of an object applying the force.

29. The computing device of claim 27, further comprising logic to determine a type of deformation of the flexible sensor.

30. The computing device of claim 27, further comprising logic to determine an amount of deformation of the flexible sensor.

31. The computing device of claim 27, wherein deforming the flexible sensor comprises compressing the flexible sensor, stretching the flexible sensor vertically, stretching the flexible sensor horizontally, bending the flexible sensor, twisting the flexible sensor, or a combination thereof.

32. The computing device of claim 27, wherein the flexible sensor comprises a flexible polymer.
